(19) United States
(12) Patent Application Publication
(10) Pub. No.: US 2026/0046859 A1
(43) Pub. Date: Feb. 12, 2026

(54) METHOD AND APPARATUS FOR INTELLIGENT BEAM MANAGEMENT IN COMMUNICATION NETWORK

(71) Applicant: ELECTRONICS AND TELECOMMUNICATIONS RESEARCH INSTITUTE, Daejeon (KR)

(72) Inventors: Yong Jin KWON, Daejeon (KR); Seungjae BAHNG, Daejeon (KR); Youngjoon YOON, Daejeon (KR); Anseok LEE, Daejeon (KR); Heesoo LEE, Daejeon (KR); Hyun Seo PARK, Daejeon (KR); Yunjoo KIM, Daejeon (KR); Jungsook BAE, Daejeon (KR); Jungbo SON, Daejeon (KR); Yu Ro LEE, Daejeon (KR)

(73) Assignee: ELECTRONICS AND TELECOMMUNICATIONS RESEARCH INSTITUTE, Daejeon (KR)

(21) Appl. No.: 19/291,940

(22) Filed: Aug. 6, 2025

(30) Foreign Application Priority Data
Aug. 9, 2024 (KR) 10-2024-0106689
Sep. 26, 2024 (KR) 10-2024-0131152
Jul. 30, 2025 (KR) 10-2025-0104526

(51) Int. Cl. H04W 72/044

(52) U.S. Cl. CPC H04W 72/046

(57) ABSTRACT

A method of a base station may comprise: configuring a first resource set and a second resource set for training and inference operations of an artificial intelligence/machine learning (AI/ML) model; determining whether the first resource set and the second resource set are identical and configuring an associated identifier (ID) for each of the first resource set and the second resource set; and transmitting a signal to a terminal based on at least one of a plurality of beams corresponding to the associated ID of the first resource set or a plurality of beams corresponding to the associated ID of the second resource set.

### CROSS-REFERENCE TO RELATED APPLICATIONS

This application claims priority to Korean Patent Applications No. 10-2024-0106689, filed on Aug. 9, 2024, No. 10-2024-0131152, filed on Sep. 26, 2024, and No. 10-2025-0104526, filed on Jul. 30, 2025, with the Korean Intellectual Property Office (KIPO), the entire contents of which are hereby incorporated by reference.

### BACKGROUND

### 1. Technical Field

The present disclosure relates to an intelligent beam management technique in a communication network, and more particularly, to a method and an apparatus for intelligent beam management, which ensure consistency in training and inference operations of AI/ML models.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Recently, there has been active discussion on utilizing intelligent technologies based on artificial intelligence (AI) or machine learning (ML) models (e.g. AI/ML models). The intelligent technologies may be applied in various areas such as enhancing channel state information (CSI) feedback, improving beam management, or increasing positioning accuracy in communication systems.

AI/ML models may be generated through training based on data collection. The AI/ML models may be deployed or activated. Through inference for a specific intelligent functionality, the AI/ML models may perform intelligent operations.

To improve the performance of intelligent functionality, the AI/ML model needs to maintain consistency in operational performance. Accordingly, there is a demand for methods that can ensure consistency between training operations and inference operations of the AI/ML models.

### SUMMARY

The present disclosure for resolving the above-described problems is directed to providing a method and an apparatus for intelligent beam management, which ensure consistency in training and inference operations of AI/ML models.

A method of a base station for intelligent beam management, according to exemplary embodiments of the present disclosure, may comprise: configuring a first resource set and a second resource set for training and inference operations of an artificial intelligence/machine learning (AI/ML) model; determining whether the first resource set and the second resource set are identical and configuring an associated identifier (ID) for each of the first resource set and the second resource set; and transmitting a signal to a terminal based on at least one of a plurality of beams corresponding to the associated ID of the first resource set or a plurality of beams corresponding to the associated ID of the second resource set.

Each of the first resource set and the second resource set may include Set A and Set B, and the configuring of the first resource set and the second resource set may comprise: configuring at least one of the Set A and the Set B in one resource configuration information element (IE) among a plurality of IEs according to a channel state information (CSI) framework.

Each of the first resource set and the second resource set may further includes Set C, and the configuring of the first resource set and the second resource set may further comprise: configuring the Set C by selecting one or more resource set IEs from among a plurality of resource set IEs of a new IE.

The configuring of the associated ID may comprise: determining whether a plurality of beams of the first resource set and a plurality of beams of the second resource set are identical; based on a determination that the plurality of beams of the first resource set are identical to the plurality of beams of the second resource set, configuring an identical associated ID to each of the first resource set and the second resource set; and based on a determination that the plurality of beams of the first resource set are not identical to the plurality of beams of the second resource set, configuring different associated IDs to the first resource set and the second resource set.

The determining of whether the plurality of beams of the first resource set and the plurality of beams of the second resource set are identical may comprise: determining whether at least one of beam direction, beam order, beam transmission configuration indicator (TCI) state ID, or beam CSI reference signal resource indicator (CRI) value is identical between the plurality of beams of the first resource set and the plurality of beams of the second resource set.

The configuring of the associated ID may comprise: determining whether the second resource set is a subset of the first resource set; and based on a determination that the second resource set is a subset of the first resource set, configuring a subset ID together with the associated ID.

The configuring of the associated ID may comprise: configuring time stamp information for a time of configuring the associated ID for each of the first resource set and the second resource set.

The configuring of the associated ID may comprise: configuring a cell-specific associated ID in a portion of an entire bit region for the associated ID; and configuring a vendor-specific associated ID in a remaining portion of the entire bit region for the associated ID.

Abase station for intelligent beam management, according to exemplary embodiments of the present disclosure, may comprise at least one processor, wherein the at least one processor may cause the base station to perform: configuring a first resource set and a second resource set for training and inference operations of an artificial intelligence/machine learning (AI/ML) model; determining whether the first resource set and the second resource set are identical and configuring an associated identifier (ID) for each of the first resource set and the second resource set; and transmitting a signal to a terminal based on at least one of a plurality of beams corresponding to the associated ID of the first resource set or a plurality of beams corresponding to the associated ID of the second resource set.

Each of the first resource set and the second resource set may include Set A and Set B, and in the configuring of the first resource set and the second resource set, the at least one processor may further cause the base station to perform: configuring at least one of the Set A and the Set B in one resource configuration information element (IE) among a plurality of IEs according to a channel state information (CSI) framework.

Each of the first resource set and the second resource set may further include Set C, and in the configuring of the first resource set and the second resource set, the at least one processor may further cause the base station to perform: configuring the Set C by selecting one or more resource set IEs from among a plurality of resource set IEs of a new IE.

In the configuring of the associated ID, the at least one processor may further cause the base station to perform: determining whether a plurality of beams of the first resource set and a plurality of beams of the second resource set are identical; based on a determination that the plurality of beams of the first resource set are identical to the plurality of beams of the second resource set, configuring an identical associated ID to each of the first resource set and the second resource set; and based on a determination that the plurality of beams of the first resource set are not identical to the plurality of beams of the second resource set, configuring different associated IDs to the first resource set and the second resource set.

In the determining of whether the plurality of beams of the first resource set and the plurality of beams of the second resource set are identical, the at least one processor may further cause the base station to perform: determining whether at least one of beam direction, beam order, beam transmission configuration indicator (TCI) state ID, or beam CSI reference signal resource indicator (CRI) value is identical between the plurality of beams of the first resource set and the plurality of beams of the second resource set.

In the configuring of the associated ID, the at least one processor may further cause the base station to perform: determining whether the second resource set is a subset of the first resource set; and based on a determination that the second resource set is a subset of the first resource set, configuring a subset ID together with the associated ID.

In the configuring of the associated ID, the at least one processor may further cause the base station to perform: configuring time stamp information for a time of configuring the associated ID for each of the first resource set and the second resource set.

In the configuring of the associated ID, the at least one processor further causes the base station to perform: configuring a cell-specific associated ID in a portion of an entire bit region for the associated ID; and configuring a vendor-specific associated ID in a remaining portion of the entire bit region for the associated ID.

A method of a terminal for intelligent beam management, according to exemplary embodiments of the present disclosure, may comprise: receiving, from a base station, a signal based on a plurality of beams for a first resource set at a first time; performing a training operation of an artificial intelligence/machine learning (AI/ML) model using the plurality of beams of the first resource set; receiving, from the base station, a signal based on a plurality of beams for a second resource set at a second time; determining whether an associated ID of the first resource set is identical to an associated ID of the second resource set; and based on a determination that the associated ID of the first resource set is identical to the associated ID of the second resource set, performing an inference operation of the AI/ML model using the plurality of beams of the second resource set.

The performing of the inference operation may comprise: comparing first time stamp information at a time of configuring the associated ID for the first resource set with second time stamp information at a time of configuring the associated ID for the second resource set; and based on the second time stamp information being more recent than the first time stamp information, discarding the plurality of beams of the first resource set.

According to the present disclosure, a base station may determine whether a plurality of resource sets configured for training or inference operations of an AI/ML model are identical, and may configure an associated ID for each of the resource sets accordingly. A terminal may perform training and inference operations for the AI/ML model using a plurality of beams having the same associated ID and received from the base station at different times. Accordingly, the terminal can maintain consistency between the training and inference operations of the AI/ML model for intelligent beam management and can prevent degradation in the inference performance of the AI/ML model due to environmental changes.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating an exemplary embodiment of intelligent beam management of the communication network.

FIG. 4 is a conceptual diagram illustrating an exemplary embodiment of intelligent positioning of the communication network.

FIG. 5 is a conceptual diagram illustrating an exemplary embodiment of intelligent channel information feedback of the communication network.

FIG. 6 is a conceptual diagram illustrating an exemplary embodiment of an AI/ML model for intelligent beam management.

FIG. 7 is a conceptual diagram illustrating an exemplary embodiment of an intelligent beam management operation of the terminal.

FIG. 8 is a sequence chart illustrating an exemplary embodiment of an intelligent beam management operation of the terminal.

FIG. 9 is a conceptual diagram illustrating an exemplary embodiment of an intelligent beam management operation of the base station.

FIG. 10 is a sequence chart illustrating an exemplary embodiment of an intelligent beam management operation of the base station.

FIG. 11 is a conceptual diagram illustrating an exemplary embodiment of a framework structure for configuring resource sets of an AI/ML model.

FIG. 12 is a conceptual diagram illustrating an exemplary embodiment of a resource set configuration operation for an AI/ML model.

FIG. 13 is a conceptual diagram illustrating an exemplary embodiment of a resource set configuration operation for an AI/ML model.

FIG. 14 is a conceptual diagram illustrating an exemplary embodiment of a resource set configuration operation for an AI/ML model.

FIG. 15 is a conceptual diagram illustrating an exemplary embodiment of a resource set configuration operation for the AI/ML model.

FIG. 16 is a conceptual diagram illustrating an exemplary embodiment of a resource set configuration operation for an AI/ML model.

FIG. 17 is a conceptual diagram illustrating an exemplary embodiment for ensuring consistency of resource sets of an AI/ML model.

FIG. 18 is a conceptual diagram illustrating an exemplary embodiment of an associated ID for ensuring consistency of an AI/ML model.

FIG. 19 is a conceptual diagram illustrating an exemplary embodiment of resource sets having different associated IDs.

FIG. 20 is a conceptual diagram illustrating an exemplary embodiment of resource sets having different associated IDs.

FIG. 21 is a conceptual diagram illustrating an exemplary embodiment of resource sets having the same associated ID.

FIG. 22 is a conceptual diagram illustrating an exemplary embodiment of an associated ID for ensuring consistency of an AI/ML model.

FIG. 23 is a conceptual diagram illustrating an exemplary embodiment of resource sets having different associated IDs.

FIG. 24 is a conceptual diagram illustrating an exemplary embodiment of resource sets having different associated IDs.

FIG. 25 is a conceptual diagram illustrating an exemplary embodiment for ensuring consistency of an AI/ML model.

FIG. 26 is a conceptual diagram illustrating an exemplary embodiment for ensuring consistency of an AI/ML model.

FIG. 27 is a conceptual diagram illustrating an exemplary embodiment for ensuring consistency of an AI/ML model for a moving terminal.

FIG. 28 is a conceptual diagram illustrating an exemplary embodiment of an associated ID for ensuring consistency of an AI/ML model for a moving terminal.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re)transmission” may mean “transmission”, “retransmission”, or “transmission and retransmission”, “(re)configuration” may mean “configuration”, “reconfiguration”, or “configuration and reconfiguration”, “(re)connection” may mean “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication network to which exemplary embodiments according to the present disclosure are applied will be described. The communication network may be a non-terrestrial network (NTN), a 4G communication network (e.g. Long-Term Evolution (LTE) communication network), a 5G communication network (e.g. New Radio (NR) communication network), or a B5G mobile communication network (e.g. 6G mobile communication network). The 4G communication network and the 5G communication network may be classified as terrestrial networks.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

Hereinafter, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

In the present disclosure, a phrase including “when ˜” may be expressed as a phrase including “based on ˜” or “in response to ˜”. In other words, a phrase including “when ˜” may be interpreted as being the same as or similar to a phrase including “based on ˜” or “in response to ˜”.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

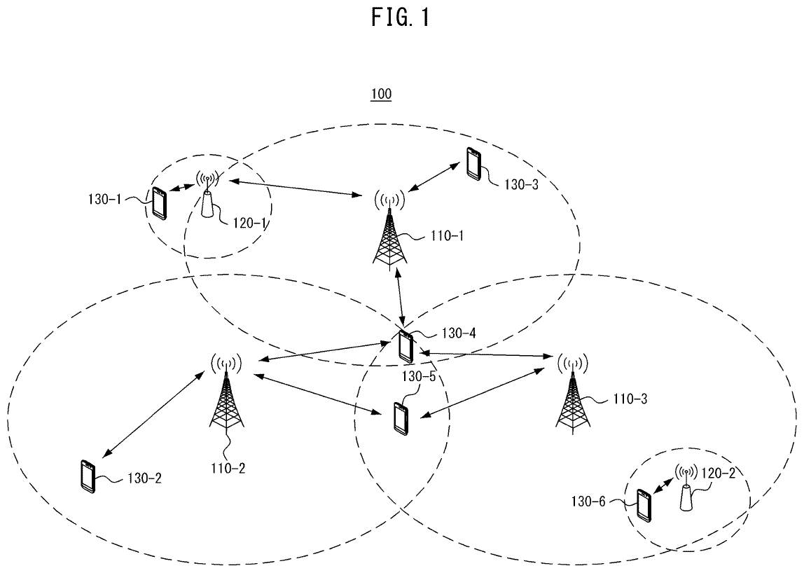

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes 110-1, 110-2, 110-3, 120-1, 120-2, 130-1, 130-2, 130-3, 130-4, 130-5, and 130-6 may include a plurality of base stations 110-1, 110-2, 110-3, 120-1, and 120-2) and a plurality of terminals, for example, a plurality of user terminals 130-1, 130-2, 130-3, 130-4, 130-5, and 130-6.

Each of the plurality of communication nodes 110-1, 110-2, 110-3, 120-1, 120-2, 130-1, 130-2, 130-3, 130-4, 130-5, and 130-6 may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network (not shown). When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

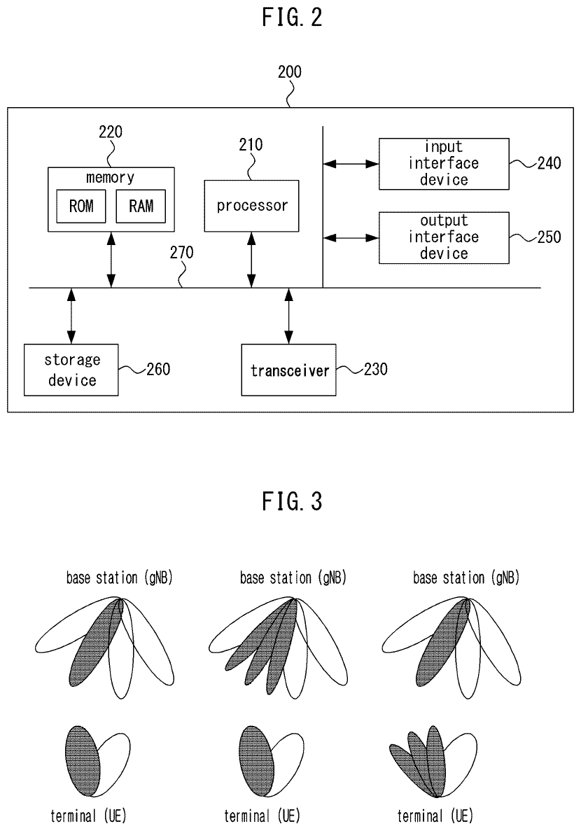

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed.

Each of the memory 220 and the storage device 260 may be constituted by at least one of a volatile storage medium and a non-volatile storage medium. For example, the memory 220 may comprise at least one of read-only memory (ROM) and random access memory (RAM).

The communication node 200 may include an intelligent model (e.g. AI/ML model) for performing an intelligent function based on intelligent technology. The AI/ML model may be classified into a one-sided type model and a two-sided type model. The one-sided type model may be a type in which one of a base station and a terminal among a plurality of communication nodes includes the AI/ML model. The two-sided type model may be a type in which both the base station and the terminal among the plurality of communication nodes include the AI/ML model.

The communication node 200 may perform life cycle management (LCM) for the intelligent functionalities, model generation, or maintenance of the AI/ML model. The LCM may include detailed stages such as data collection, model training, model inference, model deployment, model activation, model deactivation, model selection, model switching, model fallback, and model monitoring.

The communication node 200 may identify an intelligent functionality supported by the communication network 100 or may identify an AI/ML model that performs the intelligent functionality. For example, the base station may identify intelligent functionalities or AI/ML models supported by the terminal and may instruct the terminal to activate a specific intelligent functionality or AI/ML model based on the identified intelligent functionalities or AI/ML models.

The communication node 200 may perform LCM for the AI/ML model based on the identification of the intelligent functionality or the identification of the AI/ML model. For example, the communication node 200 may perform functionality-based LCM for the AI/ML model, or may perform model ID-based LCM for the AI/ML model. The functionality-based LCM may be a process in which the base station and the terminal share functionality information for intelligent functionalities in advance and identify and manage the intelligent functionalities based on the shared functionality information. The model ID-based LCM may be a process in which the base station and the terminal share model information together with model IDs in advance, and identify and manage the AI/ML models based on the shared model information and the model IDs.

As described above, the communication network 100 of the present disclosure may perform a specific intelligent functionality based on intelligent technology using an AI/ML model included in at least one of the plurality of communication nodes 110-1, 110-2, 110-3, 120-1, 120-2, 130-1, 130-2, 130-3, 130-4, 130-5, and 130-6. The specific intelligent functionality may include enhancement of intelligent channel information feedback of the communication network 100, enhancement of intelligent positioning, or intelligent beam management.

FIG. 3 is a conceptual diagram illustrating an exemplary embodiment of intelligent beam management of the communication network.

Referring to FIG. 3, an intelligent functionality using an AI/ML model may be applied to a beam management method capable of improving a reach of directionals beam in the communication network.

For example, when directional beams are used in the communication network, a process of selecting a base station beam (i.e. Tx beam) and a terminal beam (i.e. Rx beam) among a plurality of beams that show optimal performance may be required to ensure stable link performance between the base station and the terminal. A conventional beam management method for selecting optimal beams may cause performance degradation or increased power consumption due to frequent overhead.

The beam management method to which the intelligent functionality is applied can reduce overhead generated in beam measurement for optimal beam selection and may improve the accuracy of optimal beam selection. The beam management method to which the intelligent functionality is applied may perform beam prediction for predicting a beam of an unobserved resource in the spatial domain or temporal domain.

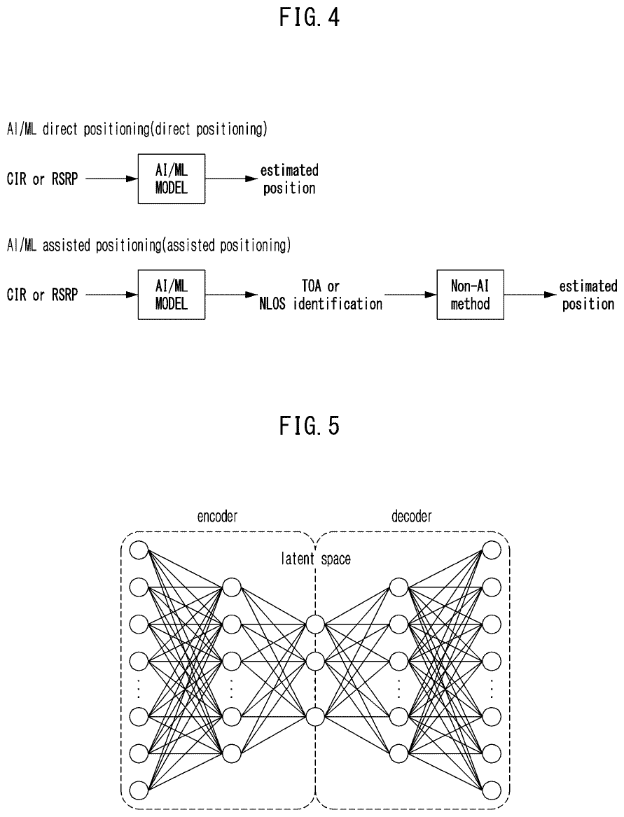

FIG. 4 is a conceptual diagram illustrating an exemplary embodiment of intelligent positioning of the communication network.

Referring to FIG. 4, an intelligent functionality using an AI/ML model may be applied to a method to improve positioning accuracy in estimating a position of a specific terminal in the communication network.

The method for improving positioning accuracy to which the intelligent functionality is applied may include a direct AI/ML positioning method or an AI/ML assisted positioning method using the AI/ML model. The direct positioning method may be a method in which the AI/ML model receives channel impulse response signals (CIRs) or reference signal received powers (RSRPs) as input and outputs an estimated position of the terminal. The assisted positioning method may be a method in which the AI/ML model receives CIRs or RSRPs as input, outputs a time of arrival (TOA) or a non-line-of-sight (NLOS) identification result, and outputs an estimated position of the terminal using the TOA and the NLOS identification result.

FIG. 5 is a conceptual diagram illustrating an exemplary embodiment of intelligent channel information feedback of the communication network.

Referring to FIG. 5, an intelligent functionality using an AI/ML model may be applied to a method for improving channel information feedback of the communication network. Channel information feedback (CSI feedback) may refer to a process in which the terminal reports channel state information (CSI) so that the base station in the communication network is able to apply a transmission technique such as multiple input multiple output (MIMO) or precoding. The CSI feedback may support feedback information such as channel quality indication (CQI), precoding matrix indication (PMI), and/or rank indication (RI).

The intelligent functionality may be applied to an autoencoder and may perform CSI compression for acquiring a compressed latent representation for a MIMO channel through the autoencoder. For example, the autoencoder may include an encoder, a decoder, and hidden layer(s) between the encoder and the decoder. The autoencoder may set the number of neurons in the hidden layer(s) to be less than that of an input layer so that data compression (or dimensionality reduction) is performed.

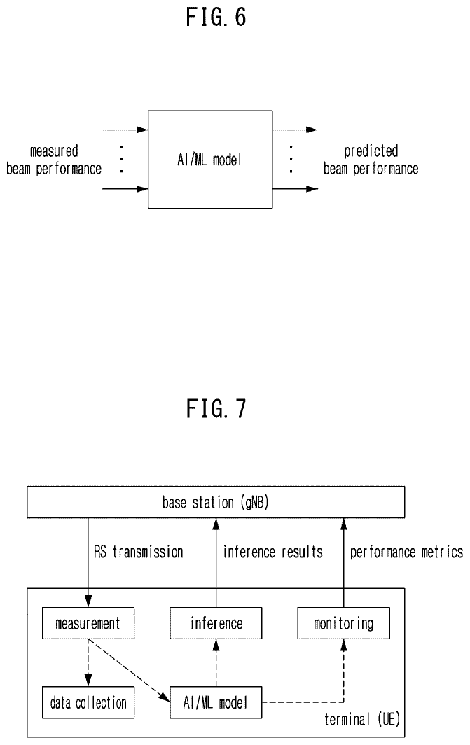

FIG. 6 is a conceptual diagram illustrating an exemplary embodiment of an AI/ML model for intelligent beam management.

Referring to FIG. 6, a base station or a terminal of the communication network may include an AI/ML model for intelligent beam management. The AI/ML model may select a beam having optimal performance through an inference operation.

The network (e.g. base station) may determine at least one reference signal (RS) corresponding to at least one beam based on a synchronization signal block (SSB) or a channel state information reference signal (CSI-RS). The base station may transmit the at least one RS to the terminal.

The terminal may receive the RS(s) from the base station. The terminal may measure the performance of the RS(s) and may provide the measurement result, that is, the measured beam performance, as input to the AI/ML model. The measured beam performance may be a layer 1 reference signal received power (L1-RSRP) or a layer 1 signal to interference pulse noise ratio (L1-SINR).

The AI/ML model may receive the measured beam performance from the terminal. The AI/ML model may perform an inference operation based on the measured beam performance and may output an inference result. The AI/ML model may output an index of a beam having optimal performance or performance for all beams, for example, L1-RSRP(s), as the inference result.

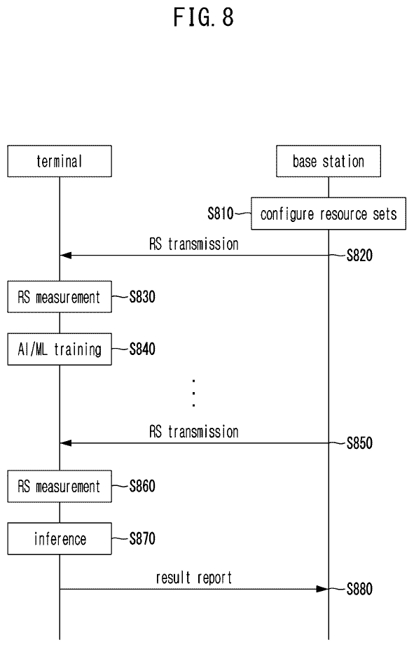

FIG. 7 is a conceptual diagram illustrating an exemplary embodiment of an intelligent beam management operation of the terminal, and FIG. 8 is a sequence chart illustrating an exemplary embodiment of an intelligent beam management operation of the terminal.

Referring to FIGS. 7 and 8, the terminal may include an AI/ML model. For the AI/ML model, operations such as RS measurement, data collection, model training, inference, or model monitoring may be performed.

The network (e.g. base station) may configure resource sets for generation of reference signals (RSs) (S810). Each resource set may include a plurality of resources, and each of the plurality of resources may correspond to a beam, and may be an RS resource.

The base station may separately configure a resource set for training of the AI/ML model and a resource set for inference of the AI/ML model of the terminal. The base station may configure a first resource set for a training operation of the AI/ML model and a second resource set for an inference operation of the AI/ML model. In addition, the base station may configure a third resource set for performance monitoring of the AI/ML model of the terminal. Each of the first resource set and the second resource set may include resource sets Set A and Set B corresponding to input and output of the AI/ML model, respectively. The third resource set may include a resource set Set C corresponding to the input of the AI/ML model.

The base station may generate a plurality of beams, for example, a plurality of RSs, based on the configured resource set. For example, the base station may generate a plurality of beams for Set A of the first resource set and a plurality of beams for Set B of the first resource set.

The base station may transmit the plurality of RSs for the first resource set to the terminal (S820). The terminal may receive the plurality of RSs from the base station and may measure the performance of the received RSs (S830).

The terminal may perform training of the AI/ML model using the RS performance measurement result, for example, measured beam performance (S840). For example, the AI/ML model may receive the performance measurement result for Set B of the first resource set and may be trained to output the performance measurement result for Set A of the first resource set. According to an exemplary embodiment, the AI/ML model may further receive labeling information including actual performance measurement values (i.e. ground truth values) for each of Set A and Set B.

After the training of the AI/ML model of the terminal is completed, the base station may transmit a plurality of RSs for the second resource set to the terminal (S850). The terminal may receive the plurality of RSs from the base station and may measure the performance of the received RSs (S860).

The terminal may perform an inference operation of the AI/ML model based on the RS performance measurement result (S860). For example, the AI/ML model may receive the performance measurement result for Set B of the second resource set and may output a result through the inference operation, for example, predicted beam performance. The terminal may transmit the inference result output from the AI/ML model to the base station (S880).

According to an exemplary embodiment, the terminal may calculate a performance metric of the AI/ML model based on the inference result of the AI/ML model. The terminal may transmit the performance metric of the AI/ML model to the base station.

The terminal may maintain operational consistency of the AI/ML model to improve the performance of intelligent beam management through the AI/ML model. For example, the AI/ML model of the terminal may perform model training by receiving the plurality of RSs for the first resource set from the base station. After training is completed, the AI/ML model may be deployed in the terminal and may perform the inference operation by receiving the plurality of RSs for the second resource set from the base station. Here, a time difference may occur between the training operation and the inference operation of the AI/ML model, and the training environment and the inference environment may differ due to the time difference. The AI/ML model may experience degradation in inference performance, for example, beam prediction performance, due to such environmental changes. Therefore, the base station may prevent degradation in the inference performance of the AI/ML model of the terminal by ensuring consistency between the first resource set and the second resource set.

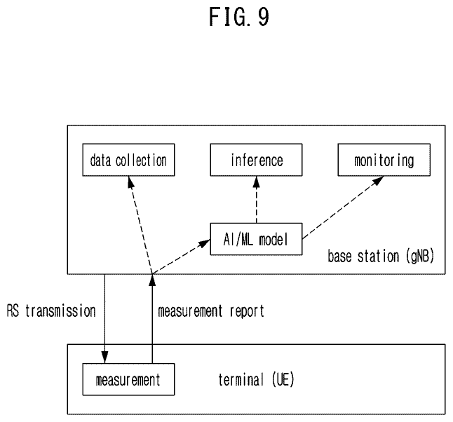

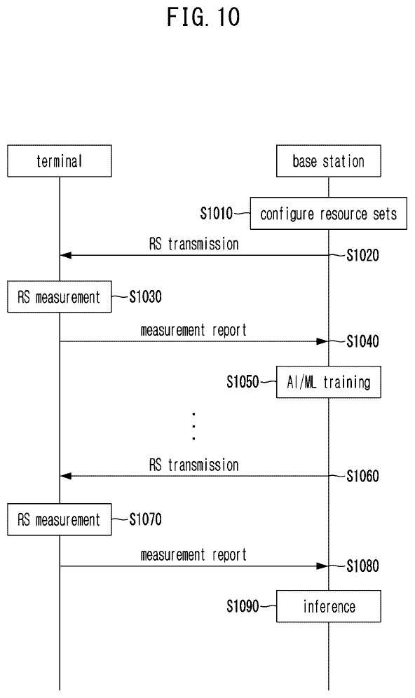

FIG. 9 is a conceptual diagram illustrating an exemplary embodiment of an intelligent beam management operation of the base station, and FIG. 10 is a sequence chart illustrating an exemplary embodiment of an intelligent beam management operation of the base station.

Referring to FIGS. 9 and 10, the network (i.e. base station) may include an AI/MVL model. For the AI/ML model, operations such as data collection, model training, inference, or model monitoring may be performed.

The base station may configure resource sets for generation of RSs (S1010). The base station may configure a first resource set for a training operation of the AI/ML model and a second resource set for an inference operation of the AI/ML model. Each of the first resource set and the second resource set may include resource sets Set A and Set B corresponding to input and output of the AI/ML model, respectively.

The base station may generate a plurality of beams, for example, a plurality of RSs, based on the configured resource sets. For example, the base station may generate a plurality of beams for Set A of the first resource set and a plurality of beams for Set B of the first resource set.

The base station may transmit the plurality of RSs for the first resource set to the terminal (S1020). The terminal may receive the plurality of RSs from the base station and may measure the performance of the received RSs (S1030). The terminal may transmit the RS performance measurement result, for example, measured beam performance for each of Set A and Set B of the first resource set, to the base station (S1040).

The base station may perform training of the AI/ML model based on the performance measurement result received from the terminal (S1050). For example, the AI/ML model may receive the performance measurement result for Set B of the first resource set and may be trained to output the performance measurement result for Set A of the first resource set. According to an exemplary embodiment, the AI/ML model may further receive labeling information including actual performance measurement values for each of Set A and Set B.

After the training of the AI/ML model is completed, the base station may transmit a plurality of RSs for the second resource set to the terminal (S1060). The terminal may receive the plurality of RSs from the base station and may measure the performance of the received RSs (S1070). The terminal may transmit the RS performance measurement result, for example, measured beam performance for each of Set A and Set B of the second resource set, to the base station (S1080).

The base station may perform an inference operation of the AI/ML model based on the performance measurement result received from the terminal (S1090). For example, the AI/ML model may receive the performance measurement result for Set B of the second resource set and may output a result through the inference operation, for example, predicted beam performance. According to an exemplary embodiment, the base station may calculate a performance metric of the AI/ML model based on the inference result of the AI/ML model.

According to an exemplary embodiment, the base station may ensure consistency between the first resource set and the second resource set transmitted to the terminal in order to prevent degradation in inference performance due to changes between the training environment and the inference environment of the AI/ML model.

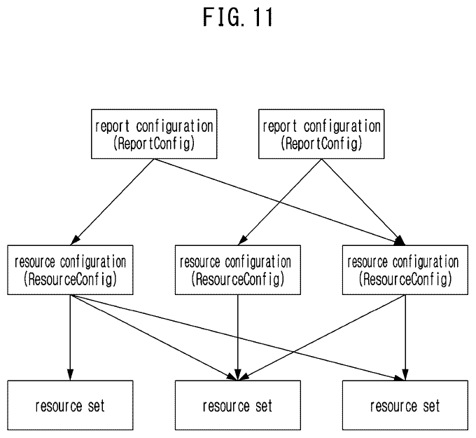

FIG. 11 is a conceptual diagram illustrating an exemplary embodiment of a framework structure for configuring resource sets of an AI/ML model.

Referring to FIG. 11, the base station may configure resource sets each including at least one resource in order to generate RS(s) for training or inference of the AI/ML model. The base station may configure the resource sets for intelligent beam management of the AI/MVL model based on a framework structure for CSI reporting.

The CSI framework shown in FIG. 11 may include a plurality of information elements (IEs). The plurality of IEs may include at least one of a report configuration IE (ReportConfig), a resource configuration IE (ResourceConfig), or a resource set IE.

At least one report configuration IE may be distinguished by reportConfigId as shown in Table 1 below. Resources that may be used for channel measurement or interference measurement may be included using ResourceConfigId, respectively. The report configuration IE may configure a time domain operation of CSI reporting to be periodic, semi-persistent, or aperiodic through reportConfigType. The report configuration IE may configure the content of CSI reporting through reportQuantity.

TABLE 1

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH- |

CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {sl5, sl10, sl20, sl40, sl80, sl160, sl320}, |
| reportSlotOffsetList | SEQUENCE (SIZE (1.. maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) OF |

```
INTEGER(0..32)
    }
  },
```

| reportQuantity | CHOICE { | |
|---|---|---|
| none | NULL, | |
| cri-RI-PMI-CQI | NULL, | |
| cri-RI-i1 | NULL, | |
| cri-RI-i1-CQI | SEQUENCE { | |
| pdsch-BundleSizeForCSI | ENUMERATED {n2, n4} | OPTIONAL -- Need S |

},

| | |
|---|---|
| cri-RI-CQI | NULL, |
| cri-RSRP | NULL, |
| ssb-Index-RSRP | NULL, |
| cri-RI-LI-PMI-CQI | NULL |

},

At least one resource configuration IE may be distinguished by ResourceConfigId as shown in Table 2 below. ResourceConfigId may be used by the report configuration IE to reference the corresponding resource configuration IE.

csi-RS-ResourceSetList may include nzp-CSI-RS-ResourceSetList, csi-SSB-ResourceSetList, and csi-IM-ResourceSetList. nzp-CSI-RS-ResourceSetList may include resources to be used for CSI reporting by the terminal. csi-IM-ResourceSetList may include resources to be used for channel interference measurement and reporting. csi-SSB-ResourceSetList may include SSB resources used for channel measurement and reporting. The resource configuration IE may configure a time domain operation of CSI reporting to be periodic, semi-persistent, or aperiodic through resourceType.

TABLE 2

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |
| nzp-CSI-RS-ResourceSetList | SEQUENCE (SIZE (1..maxNrofNZP-CSI-RS- |

ResourceSetsPerConfig)) OF NZP-CSI-RS-ResourceSetId

OPTIONAL, -- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId OPTIONAL -- Need R
},

| | |
|---|---|
| csi-IM-ResourceSetList | SEQUENCE (SIZE (1..maxNrofCSI-IM-ResourceSetsPerConfig)) |

OF CSI-IM-ResourceSetId
},

| | |
|---|---|
| bwp-Id | BWP-Id, |
| resourceType | ENUMERATED { aperiodic, semiPersistent, periodic }, |

```
  ...,
  [[
```

| | | |
|---|---|---|
| csi-SSB-ResourceSetListExt-r17 | CSI-SSB-ResourceSetId | OPTIONAL -- Need R |

]]
}

The CSI framework described above may have a structure in which the plurality of IEs refer to each other, and through this, information on resources to be used for CSI reporting may be transmitted to the terminal. For example, one report configuration may refer to at least one resource configuration. One resource configuration may refer to at least one resource set. The base station may configure resource sets for training or inference of the AI/ML model based on the CSI framework structure.

Each of Set A and Set B of the resource set may be configured using the CSI-ReportConfig IE. According to an exemplary embodiment, Set A and Set B may be configured using one CSI-ResourceConfigId. Accordingly, information on each of Set A and Set B may be included within one resource configuration. According to another exemplary embodiment, two CSI-ResourceConfigIds may be used to configure Set A and Set B, respectively. According to still another exemplary embodiment, Set B may be configured using one CSI-ResourceConfigId, and Set A may be configured using a separate resource set other than the one CSI-ResourceConfigId.

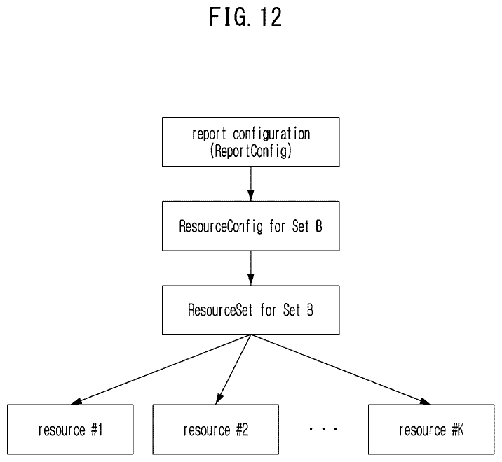

FIG. 12 is a conceptual diagram illustrating an exemplary embodiment of a resource set configuration operation for an AI/ML model.

Referring to FIG. 12, the base station may configure one resource set for a training or inference operation of the AI/ML model in one resource configuration IE. For example, the base station may configure Set B of the first resource set in one resource configuration IE. Set B may include at least one resource.

The base station may include Set B in nzp-CSI-RS-ResourceSetList or may include Set B by additionally adding a separate ResourceSetList (e.g. AI-BM-SetB-ResourceSetList). When the ResourceSetList is not added, the base station may additionally include an indicator so that the terminal may recognize that the resource set is Set B. The indicator may be included in the resource configuration or may be included in the report configuration.

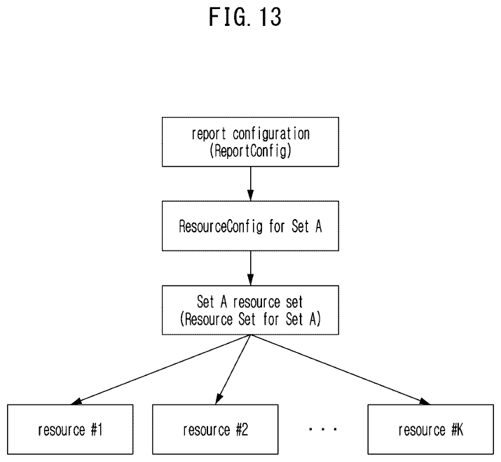

FIG. 13 is a conceptual diagram illustrating an exemplary embodiment of a resource set configuration operation for an AI/ML model.

Referring to FIG. 13, the base station may configure one resource set for a training or inference operation of the AI/ML model in one resource configuration IE. For example, the base station may configure Set A of the first resource set in one resource configuration IE. Set A may include at least one resource.

The base station may include Set A in nzp-CSI-RS-ResourceSetList or may include Set Aby additionally adding a separate ResourceSetList (e.g. AI-BM-SetA-ResourceSetList). When the ResourceSetList is not added, the base station may additionally include an indicator so that the terminal may recognize that the resource set is Set A. The indicator may be included in the resource configuration or may be included in the report configuration.

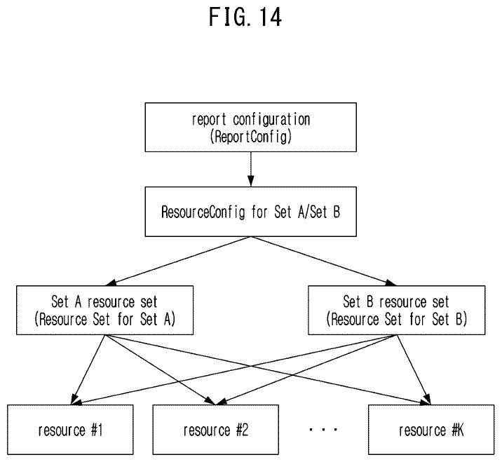

FIG. 14 is a conceptual diagram illustrating an exemplary embodiment of a resource set configuration operation for an AI/ML model.

Referring to FIG. 14, the base station may configure two resource sets for a training or inference operation of the AI/ML model in one resource configuration IE. For example, the base station may configure Set A and Set B of the first resource set in one resource configuration IE. Each of Set A and Set B may include at least one resource, and at least one resource of Set A may be the same as at least one resource of Set B.

The base station may include Set A and Set B in nzp-CSI-RS-ResourceSetList or may include Set A and Set B by additionally adding a separate ResourceSetList (e.g. AI-BM-SetB-ResourceSetList). When the ResourceSetList is not added, the base station may additionally include an indicator so that the terminal may recognize whether the resource set is Set A or Set B. The indicator may be included in the resource configuration or may be included in the report configuration.

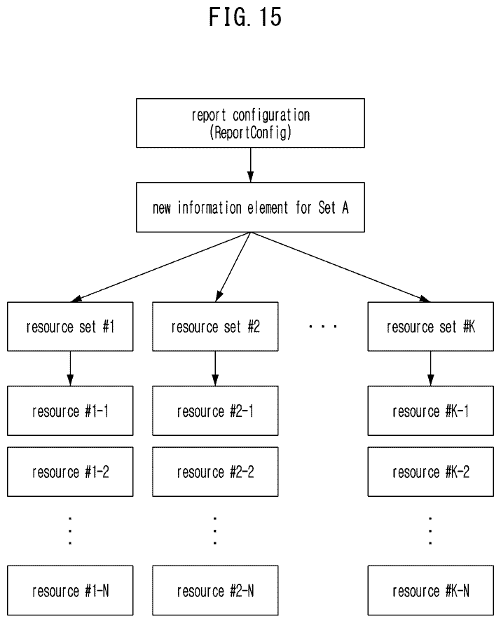

FIG. 15 is a conceptual diagram illustrating an exemplary embodiment of a resource set configuration operation for the AI/ML model.

Referring to FIG. 15, the base station may configure one resource set for a training or inference operation of the AI/ML model, for example, Set A of the first resource set. Set A may include a relatively large number of resources compared to Set B. For example, Set B may be a subset of Set A.

The base station may configure a new IE that may replace an existing resource configuration IE to configure Set A. The new IE may include a plurality of resource set IEs for Set A. Each of the plurality of resource set IEs may include a plurality of resources for Set A.

The base station may perform individual control for each of the plurality of resource set IEs for Set A. For example, the base station may activate or deactivate one of the resource set IEs among the plurality of resource set IEs for Set A to change the configuration of the resource set IEs for Set A.

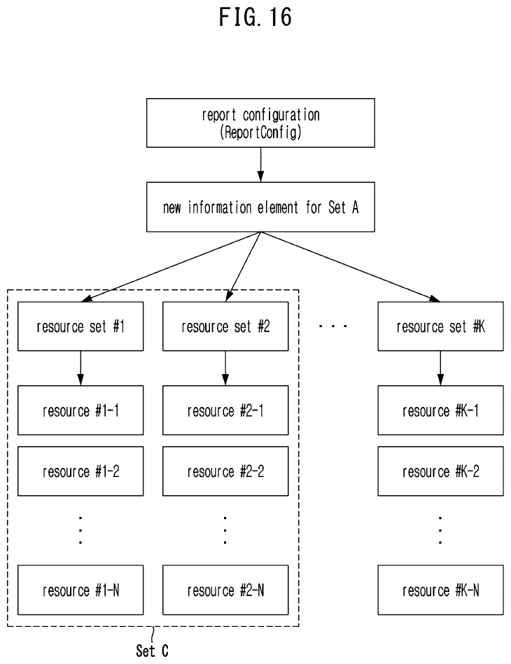

FIG. 16 is a conceptual diagram illustrating an exemplary embodiment of a resource set configuration operation for an AI/ML model.

Referring to FIG. 16, the base station may configure a resource set for performance monitoring of the AI/ML model, for example, Set C. To perform performance monitoring of the AI/ML model, the base station may transmit RSs for measurement of monitoring information to the terminal. The terminal may perform beam measurement based on the received RSs and may calculate a performance metric of the AI/ML model to perform a model monitoring operation. To perform the performance monitoring of the AI/ML model, the base station may configure SetA described above as Set C or may configure a portion of the plurality of resources of Set A as Set C. This is because if all the resources of Set A are used for performance monitoring of the AI/ML model, overhead may increase, and if the resources of Set B are used, accuracy of performance monitoring may be degraded.

For example, the base station may configure a new IE to configure Set A for training of the AI/ML model. The new IE may include a plurality of resource set IEs for Set A, and each of the plurality of resource set IEs may include a plurality of resources for Set A.

The base station may select one or more resource set IEs among the plurality of resource set IEs of the previously configured Set A and may configure the selected resource set IEs as the resource set IEs for Set C. The base station may additionally include an indicator or bitmap capable of indicating one or more resource set IEs selected as Set C within the new IE.

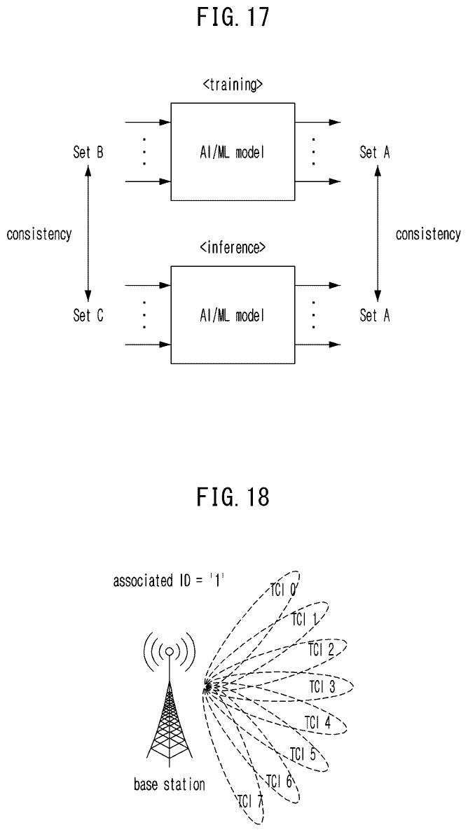

FIG. 17 is a conceptual diagram illustrating an exemplary embodiment for ensuring consistency of resource sets of an AI/ML model.

Referring to FIG. 17, the base station may configure a resource set for training of the AI/ML model, for example, Set A and Set B of the first resource set. Here, the resources of Set B may be in a subset relationship with the resources of Set A.

The base station may transmit RSs corresponding to each of the resources of Set A and Set B to the terminal. The terminal may receive the RSs from the base station and may train the AI/ML model using the received RSs. For example, the AI/ML model of the terminal may be trained to output the resources of Set A for the input resources of Set B.

After training of the AI/ML model is completed, the terminal may receive RSs for an inference operation of the AI/ML model, for example, RSs corresponding to each of the resources of Set A and Set B of the second resource set, from the base station. The AI/ML model of the terminal may output the resources of Set A through an inference operation for the input resources of Set B.

The performance of the AI/ML model of the terminal may be degraded due to environmental changes resulting from a time difference between the training operation and the inference operation. For example, a beam prediction performance of the AI/ML model in the environment where the inference operation is performed may be lower than a beam prediction performance in the environment where the training operation is performed. Therefore, the AI/ML model may prevent degradation of inference performance by ensuring consistency between the training operation and the inference operation.

The base station may establish a relationship between the first resource set and the second resource set used for the training operation and inference operation of the AI/ML model, respectively, by using specific identifiers (IDs). The terminal may identify an identifier of the first resource set and an identifier of the second resource set received from the base station. The terminal may determine whether consistency is ensured between the first resource set and the second resource set based on the result of the identification.

For example, the base station may configure an associated ID for each of the first resource set and the second resource set based on the relationship, such as identity, between Set A and Set B of the first resource set for training of the AI/ML model and Set A and Set B of the second resource set for inference of the AI/ML model. According to an exemplary embodiment, the base station may configure multiple first resource sets and second resource sets for training or inference of the AI/ML model. The base station may configure an associated ID based on whether Set A and Set B of the first resource set at a specific time and Set A and Set B of the second resource set are identical among the multiple first resource sets and second resource sets. According to an exemplary embodiment, the base station may generate an associated ID based on the relationship between Set A and Set B of the first resource set for training of the AI/ML model, or may generate an associated ID based on the relationship between Set A and Set B of the second resource set for inference of the AI/ML model.

The base station may configure information on the associated IDs of the first resource set and the second resource set in a specific IE of the CSI framework. For example, as shown in FIG. 13, the base station may configure information on the associated IDs of the first resource set and the second resource set in at least one of the report configuration IE, the resource configuration IE, the resource set IE, or the resource. Additionally, as shown in FIG. 15, the base station may configure the information on the associated IDs of the first resource set and the second resource set in a new IE configured for the first resource set or the second resource set.

The terminal may receive RSs for training of the AI/ML model from the base station and may train the AI/ML model using the received RSs. The terminal may identify the associated ID of the first resource set from the received RSs. The terminal may receive RSs for inference operation of the AI/ML model from the base station after a certain time. The terminal may identify the associated ID of the second resource set from the received RSs. The terminal may determine whether the associated ID of the first resource set for training operation of the AI/ML model and the associated ID of the second resource set for inference operation of the AI/ML model are identical. Upon determining that the associated IDs of the two resource sets are identical, the terminal may identify that a plurality of beams of the first resource set, for example, a plurality of RSs, and a plurality of beams of the second resource set are the same beams. Therefore, the AI/ML model of the terminal may maintain consistency between the training operation and the inference operation using the first resource set and the second resource set.

FIG. 18 is a conceptual diagram illustrating an exemplary embodiment of an associated ID for ensuring consistency of an AI/ML model.

Referring to FIG. 18, the base station may configure resource sets each including a plurality of resources for training or inference of the AI/ML model. The base station may configure an associated ID for a resource set for training of the AI/ML model and may configure an associated ID for a resource set for inference operation of the AI/ML model.

The associated ID may be an indicator for each of a plurality of beams corresponding to each of the plurality of resources in the resource set. Each of the plurality of beams may include transmission configuration indicator (TCI) state information as shown in Table 3.

TABLE 3

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

```
    ...,
    [[
```

| | | |
|---|---|---|
| additionalPCI-r17 | AdditionalPCIIndex-r17 | OPTIONAL, -- Need R |
| pathlossReferenceRS-Id-r17 | PathlossReferenceRS-Id-r17 | OPTIONAL, -- Cond JointTCI1 |
| ul-powerControl-r17 | Uplink-powerControlId-r17 | OPTIONAL -- Cond JointTCI |

```
    ]],
    [[
```

| | | |
|---|---|---|
| tag-Id-ptr-r18 | ENUMERATED {n0,n1} | OPTIONAL -- Cond 2TA |

```
    ]]
  }
```

| QCL-Info ::= | SEQUENCE { | |
|---|---|---|
| cell | ServCellIndex | OPTIONAL, -- Need R |
| bwp-Id | BWP-Id | OPTIONAL, -- Cond CSI-RS-Indicated |

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

The TCI state information may be distinguished by TCI-StateId, and each TCI state information may include quasi co-location (QCL) information. Base on TCI state configuration, the base station may configure or indicate up to two QCL configurations for one target antenna port. Among the two QCL configurations included in one TCI state configuration, the first QCL configuration (e.g. qcl-Type1) may be one of QCL-Type A, B, or C. The QCL configuration may be restricted according to a type of target antenna port or reference antenna port. In addition, the second QCL configuration (e.g. qcl-Type2) included in the TCI state configuration may be set to QCL-Type D and may be omitted in some cases.

As shown in FIG. 18, the base station may configure a resource set including a plurality of resources, for example, eight resources, and may configure an associated ID for the resource set. The base station may generate a plurality of beams each corresponding to each of the plurality of resources in the resource set. Each of the plurality of beams may include a different TCI state ID (e.g. TCI 0 to TCI 7). Each of the plurality of beams may express a directionality of each beam based on the TCI state ID.

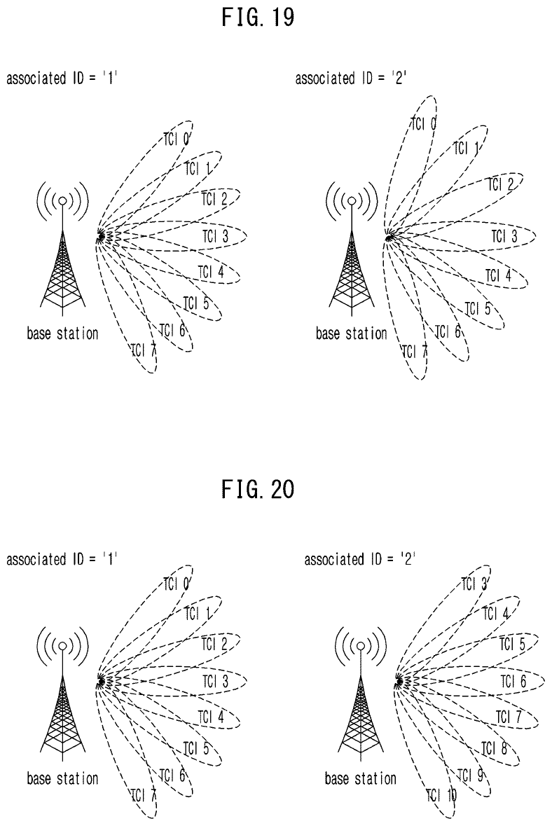

FIG. 19 is a conceptual diagram illustrating an exemplary embodiment of resource sets having different associated IDs.

Referring to FIG. 19, the base station may configure a plurality of resource sets for training or inference of the AI/ML model, for example, the first resource set and the second resource set, respectively. Each of the first resource set and the second resource set may include Set A or Set B.

The base station may generate a plurality of beams corresponding to the first resource set. Each of the plurality of beams of the first resource set may have a different TCI state ID. The base station may generate a plurality of beams corresponding to the second resource set. Each of the plurality of beams of the second resource set may have a different TCI state ID.

Among the plurality of beams of the first resource set and the plurality of beams of the second resource set, a pair of beams having the same TCI state ID may have different beam directions. Therefore, the base station may configure a different associated ID for each of the first resource set and the second resource set.

The base station may transmit a signal or channel to the terminal through the plurality of beams of the first resource set at a first time. The terminal may perform training of the AI/ML model using the plurality of beams of the first resource set. The base station may transmit a signal or channel to the terminal through the plurality of beams corresponding to the second resource set at a second time. The terminal may determine whether the associated ID of the first resource set received at the previous time (e.g. the first time) and the associated ID of the second resource set received at the current time (e.g. the second time) are identical. Since the associated ID of the first resource set and the associated ID of the second resource set have different values, the terminal may not perform the inference operation of the AI/ML model using the second resource set. The terminal may retrain the AI/ML model using the second resource set, or may wait to receive beams corresponding to a resource set of a next time from the base station.

FIG. 20 is a conceptual diagram illustrating an exemplary embodiment of resource sets having different associated IDs.

Referring to FIG. 20, the base station may configure a plurality of resource sets for training or inference of an AI/ML model, for example, the first resource set and the second resource set, respectively. Each of the first resource set and the second resource set may include Set A or Set B.

The base station may generate a plurality of beams corresponding to the first resource set. Each of the plurality of beams of the first resource set may have a different TCI state ID. The base station may generate a plurality of beams corresponding to the second resource set. Each of the plurality of beams of the second resource set may have a different TCI state ID.

Among the plurality of beams of the first resource set and the plurality of beams of the second resource set, corresponding beams, for example, a pair of beams having the same direction, may have different TCI state IDs. Therefore, the base station may configure different associated IDs for the first resource set and the second resource set.

The base station may transmit a signal or channel to the terminal through the plurality of beams of the first resource set at a first time. The terminal may perform training of the AI/ML model using the plurality of beams of the first resource set. The base station may transmit a signal or channel to the terminal through the plurality of beams corresponding to the second resource set at a second time. The terminal may determine whether the associated ID of the first resource set received at the first time and the associated ID of the second resource set received at the second time are identical. Since the associated ID of the first resource set and the associated ID of the second resource set have different values, the terminal may not perform the inference operation of the AI/ML model using the second resource set. The terminal may retrain the AI/ML model using the second resource set or may wait to receive beams corresponding to a resource set at a next time from the base station.

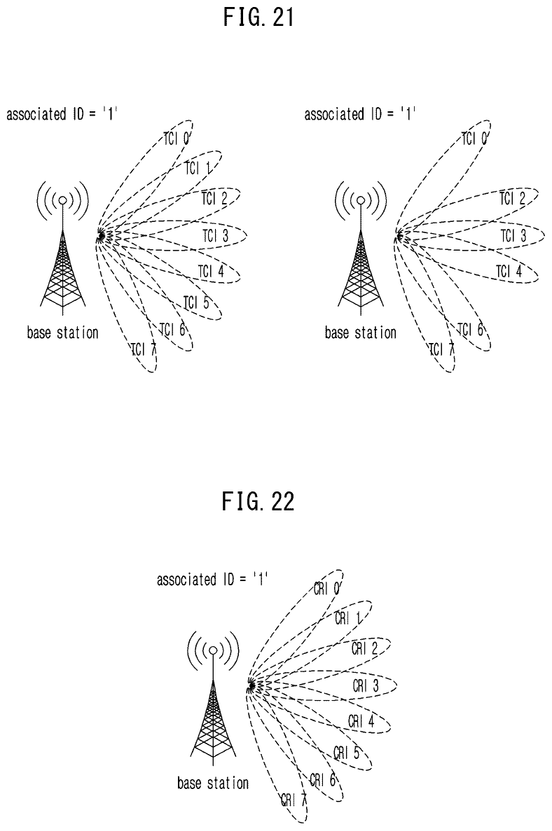

FIG. 21 is a conceptual diagram illustrating an exemplary embodiment of resource sets having the same associated ID.

Referring to FIG. 21, the base station may configure a plurality of resource sets for training or inference of the AI/ML model, for example, the first resource set and the second resource set, respectively. Each of the first resource set and the second resource set may include Set A or Set B.

The base station may generate a plurality of beams corresponding to the first resource set. Each of the plurality of beams of the first resource set may have a different TCI state ID. The base station may generate a plurality of beams corresponding to the second resource set. Each of the plurality of beams of the second resource set may have a different TCI state ID.

Among the plurality of beams of the first resource set and the plurality of beams of the second resource set, beams having the same TCI state ID may have the same direction. Therefore, the base station may configure the same associated ID for each of the first resource set and the second resource set.

The base station may transmit a signal or channel to the terminal through the plurality of beams of the first resource set at a first time. The terminal may perform training of the AI/ML model using the plurality of beams of the first resource set. The base station may transmit a signal or channel to the terminal through the plurality of beams corresponding to the second resource set at a second time. The terminal may determine whether the associated ID of the first resource set received at the first time and the associated ID of the second resource set received at the second time are identical. Since the associated ID of the first resource set and the associated ID of the second resource set are identical, the terminal may perform the inference operation of the AI/ML model using the second resource set. In this case, some of the plurality of beams of the second resource set (e.g. beams corresponding to TCI 1 and TCI 5) may not be included in the plurality of beams of the first resource set. The terminal may process the corresponding beams with a value of zero (e.g. null) and may use them for inference operation of the AI/ML model.

As described above, in the present exemplary embodiment, the base station may determine the associated ID of each of the first resource set and the second resource set based on TCI state information of the plurality of beams of each of the first resource set and the second resource set. Therefore, even when the sizes of the first resource set and the second resource set are different, the base station may configure the same associated ID if a plurality of beams in both resource sets have the same direction and the same TCI state ID, thereby providing flexibility in the change of the resource set size.

FIG. 22 is a conceptual diagram illustrating an exemplary embodiment of an associated ID for ensuring consistency of an AI/ML model.

Referring to FIG. 22, the base station may configure a resource set including a plurality of resources and may configure an associated ID for the resource set. The base station may generate a plurality of beams corresponding to each of the plurality of resources. Each of the plurality of beams may include an index indicating an order of each of the plurality of resources, for example, a CSI-RS Resource Indicator (CRI).

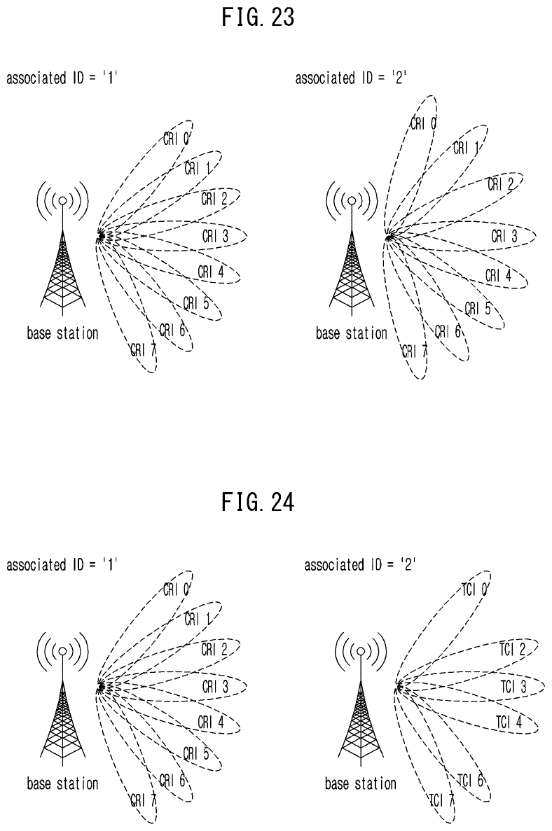

FIG. 23 is a conceptual diagram illustrating an exemplary embodiment of resource sets having different associated IDs.

Referring to FIG. 23, the base station may configure a plurality of resource sets for training or inference of the AI/ML model, for example, the first resource set and the second resource set, respectively. Each of the first resource set and the second resource set may include Set A or Set B.

The base station may generate a plurality of beams corresponding to the first resource set. Each of the plurality of beams of the first resource set may have a CRI value according to the resource order. The base station may generate a plurality of beams corresponding to the second resource set. Each of the plurality of beams of the second resource set may have a CRI value according to the resource order.

Among the plurality of beams of the first resource set and the plurality of beams of the second resource set, corresponding beams, for example, a pair of beams having the same CRI value, may have different beam directions. Therefore, the base station may configure different associated IDs for the first resource set and the second resource set.

The base station may transmit a signal or channel to the terminal through the plurality of beams of the first resource set at a first time. The terminal may perform training of the AI/ML model using the plurality of beams of the first resource set. The base station may transmit a signal or channel to the terminal through the plurality of beams corresponding to the second resource set at a second time. The terminal may determine whether the associated ID of the first resource set received at the previous time, for example, the first time, and the associated ID of the second resource set received at the current time, for example, the second time, are identical. Since the associated ID of the first resource set and the associated ID of the second resource set have different values, the terminal may not perform the inference operation of the AI/ML model using the second resource set. The terminal may retrain the AI/ML model using the second resource set or may wait to receive beams corresponding to a resource set at a next time from the base station.

FIG. 24 is a conceptual diagram illustrating an exemplary embodiment of resource sets having different associated IDs.

Referring to FIG. 24, the base station may configure a plurality of resource sets for training or inference of the AI/ML model, for example, the first resource set and the second resource set, respectively. Each of the first resource set and the second resource set may include Set A or Set B.

The base station may generate a plurality of beams corresponding to the first resource set. Each of the plurality of beams of the first resource set may have a CRI value according to the resource order. The base station may generate a plurality of beams corresponding to the second resource set. Each of the plurality of beams of the second resource set may have a CRI value according to the resource order.

The total sizes, for example, the total CRI values of the plurality of beams, of the first resource set and the second resource set may be different. Therefore, the base station may configure a different associated ID for each of the first resource set and the second resource set.

The base station may transmit a signal or a channel to the terminal through the plurality of beams of the first resource set at a first time. The terminal may perform training of the AI/ML model using the plurality of beams of the first resource set. The base station may transmit a signal or a channel to the terminal through the plurality of beams corresponding to the second resource set at a second time. The terminal may determine whether the associated ID of the first resource set received at the previous time, for example, the first time, and the associated ID of the second resource set received at the current time, for example, the second time, are identical. Since the associated ID of the first resource set and the associated ID of the second resource set have different values, the terminal may not perform the inference operation of the AI/ML model using the second resource set. The terminal may retrain the AI/ML model using the second resource set or may wait to receive beams corresponding to a resource set at a next time from the base station.

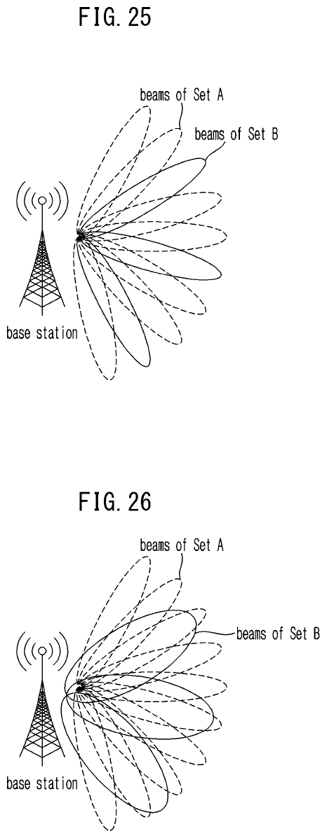

FIG. 25 is a conceptual diagram illustrating an exemplary embodiment for ensuring consistency of an AI/ML model.

Referring to FIG. 25, the base station may configure a resource set for training or inference of the AI/ML model, for example, the first resource set. The first resource set may include Set A and Set B.

The base station may determine whether Set B of the first resource set is a subset of Set A. The base station may determine that Set B is a subset of Set A and may configure, in the first resource set, an indicator representing that Set B is a subset of Set A, for example, a subset ID. The base station may configure the subset ID in a specific IE of the CSI framework, for example, in a report configuration IE, a resource configuration IE, a resource set IE, or a new IE.

The base station may configure associated ID(s) for Set A and Set B of the first resource set. The base station may configure the associated ID together with the aforementioned subset ID. For example, when Set B of the first resource set is a subset of Set A, each of the plurality of beams of Set B may be included in the plurality of beams of Set A and may have the same size, same direction, same TCI state ID, or same CRI value. Therefore, the base station may configure the same associated ID for each of Set A and Set B of the first resource set and may configure the subset ID together with the associated ID. According to an exemplary embodiment, the associated ID may be configured for Set A and may be omitted for Set B.

The base station may transmit a signal or channel to the terminal through the plurality of beams corresponding to Set A and Set B of the first resource set. The AI/ML model of the terminal may be in a state trained using a plurality of beams of a resource set transmitted from the base station at a previous time.

The terminal may determine whether the associated ID of the first resource set received at the current time and the associated ID of the resource set received at the previous time are identical. If the associated IDs of the two resource sets are identical, the terminal may verify a subset relationship between Set A and Set B based on whether a subset ID is configured for Set A and Set B of the first resource set. According to an exemplary embodiment, the terminal may verify the subset relationship between Set A and Set B by checking whether resource IDs or indexes included in the resource set of Set B are included in the resource set of Set A.

When it is confirmed that Set B is a subset of Set A, the terminal may determine that Set B of the first resource set at the current time, for example, the input to the AI/ML model, and Set B of the resource set at the previous time are the same resource set. Therefore, the terminal may perform the inference operation of the AI/ML model using the plurality of beams of the first resource set at the current time.

FIG. 26 is a conceptual diagram illustrating an exemplary embodiment for ensuring consistency of an AI/ML model.

Referring to FIG. 26, the base station may configure the first resource set for training or inference of the AI/ML model. The first resource set may include Set A and Set B.

The base station may determine whether Set B of the first resource set is a subset of Set A. It may be determined that Set B is not a subset, and a subset ID may not be configured.

The base station may configure associated IDs for Set A and Set B of the first resource set. Since the base station has determined that Set B is not a subset of Set A, the plurality of beams of Set A and the plurality of beams of Set B may have different sizes, different directions, different TCI state IDs, or different CRI values, respectively. Therefore, the base station may configure different associated IDs for Set A and Set B of the first resource set.

The base station may transmit a signal or channel to the terminal through the plurality of beams corresponding to Set A and Set B of the first resource set. The AI/ML model of the terminal may be in a state trained using a plurality of beams of a resource set transmitted from the base station at a previous time. The terminal may determine whether the associated ID of the first resource set received at the current time and the associated ID of the resource set received at the previous time are identical.

Here, since Set A and Set B of the first resource set received at the current time have different associated IDs, the terminal may determine that the associated IDs of the resource set received at the previous time and the first resource set received at the current time are not identical. The terminal may not perform the inference operation of the AI/ML model using the plurality of beams of the first resource set at the current time. The terminal may retrain the AI/ML model using the plurality of beams of the first resource set at the current time or may wait to receive beams corresponding to a resource set at a next time from the base station.

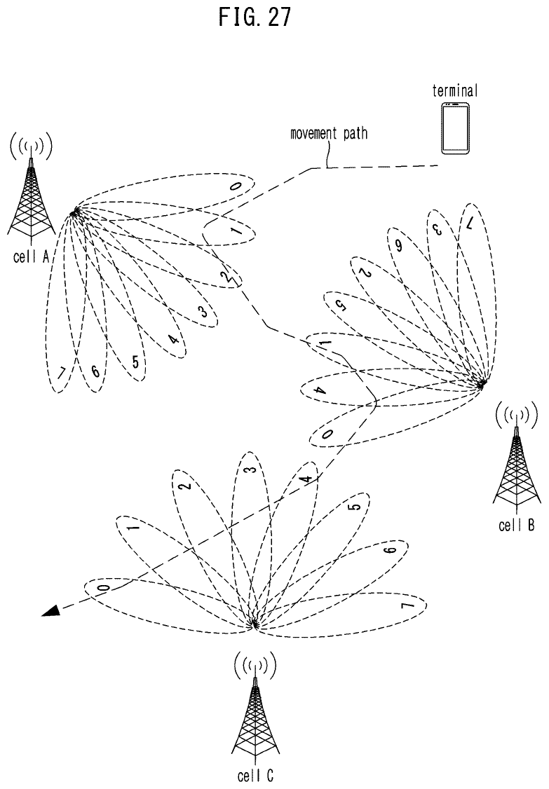

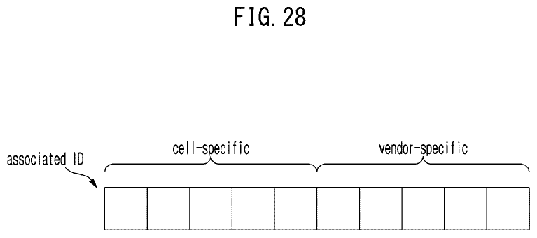

FIG. 27 is a conceptual diagram illustrating an exemplary embodiment for ensuring consistency of an AI/ML model for a moving terminal, and FIG. 28 is a conceptual diagram illustrating an exemplary embodiment of an associated ID for ensuring consistency of an AI/ML model for a moving terminal.

Referring to FIG. 27, the terminal may move along a predetermined movement path across a plurality of base stations or a plurality of cells. The terminal may be located in Cell A among a plurality of cells of a first base station. The first base station may transmit a plurality of beams corresponding to a preconfigured resource set, for example, a plurality of RS, to the terminal. The terminal may perform an intelligent beam management operation using the AI/ML model based on the plurality of beams received from the first base station. The terminal may move along the movement path and be located in Cell B among a plurality of cells of a second base station or Cell C of among a plurality of cells of a third base station. Each of the second base station and the third base station may transmit a signal or channel to the terminal through a plurality of beams corresponding to a preconfigured resource set. The terminal may perform an intelligent beam management operation using the AI/ML model based on the plurality of beams received from the first base station or the second base station.

The plurality of beams transmitted to the terminal from each of the first base station, second base station, and third base station may have different beam patterns, for example, different beam sizes, directions, TCI state IDs, or CRI values. Due to the plurality of beams having different beam patterns respectively received from the plurality of base stations, the terminal may not ensure consistency between the training and inference operations of the AI/ML model.

For example, the terminal may receive a signal or channel through the plurality of beams from the first base station with the associated ID configured as ‘1’. The terminal may perform training of the AI/ML model for intelligent beam management using the received beams. The terminal may move to a cell area of the second base station and may receive a signal or channel through the plurality of beams from the second base station with the associated ID configured as ‘1’. As described above, the plurality of beams of each of the first base station and the second base station may have different beam patterns for the same associated ID. Therefore, the terminal may not ensure consistency between the plurality of beams received from the first base station and the plurality of beams received from the second base station, and may not perform the inference operation of the AI/ML model using the plurality of beams received from the second base station. Accordingly, when the terminal moves across the cell areas of the plurality of base stations, a solution that ensures consistency between the training and inference operations of the AI/ML model of the terminal may be required.

Referring to FIG. 28, each of the plurality of base stations, for example, the first base station, the second base station, and the third base station, may configure an associated ID for the plurality of beams corresponding to a resource set configured for the training or inference operation of the AI/ML model of the terminal. Each of the plurality of base stations may configure the associated ID within a limited number of bits. For example, the associated ID may be configured within a region limited to approximately 10 bits.

Each of the plurality of base stations may divide the entire bit region of the associated ID into two regions, for example, a cell specific region and a vendor specific region. Each of the plurality of base stations may configure the associated ID for its own cell region in the cell specific region. The terminal may receive a signal or channel through the plurality of beams from the first base station configured with the associated ID in the cell specific region. The terminal may perform training of the AI/ML model using the plurality of beams received from the first base station. The terminal may move to a cell of the second base station. The terminal may receive a signal or channel through the plurality of beams from the second base station configured with the associated ID in the cell specific region. Here, when the cell of the first base station and the cell of the second base station are the same, the terminal may ensure consistency between the plurality of beams received from the first base station and the plurality of beams received from the second base station. Accordingly, the terminal may perform the inference operation of the AI/ML model using the plurality of beams received from the second base station.

In addition, each of the plurality of base stations may configure an associated ID for one or more representative beam patterns according to a manufacturer, product line, or installation environment of the base station in the vendor specific region. The terminal may receive a signal or channel through the plurality of beams from the first base station configured with the associated ID in the vendor specific region. The terminal may perform training of the AI/ML model using the plurality of beams received from the first base station. The terminal may receive a signal or channel through the plurality of beams from the second base station configured with the associated ID in the vendor specific region. Here, the first base station and the second base station may have the same manufacturer, product line, or installation environment, and accordingly, the representative beam patterns may be the same. Therefore, the terminal may ensure consistency between the plurality of beams received from the first base station and the plurality of beams received from the second base station, and may perform the inference operation of the AI/ML model using the plurality of beams received from the second base station.

Meanwhile, among the plurality of base stations, the first base station may configure a new associated ID different from the previously configured associated ID when a configuration change, for example, a beam pattern change, occurs. The first base station may transmit a signal or channel to the terminal through a plurality of beams with the new associated ID. Here, as described above, the number of bits for configuring the associated ID by the first base station may be limited. When a beam pattern change occurs in a state where all bits for configuring the associated ID have been assigned, the first base station may reuse the previously configured associated ID.

For example, the first base station may configure an associated ID for a plurality of beams at a previous time as ‘1’, and may reuse the existing associated ID ‘1’ to configure an associated ID for a plurality of beams at the current time according to the beam pattern change. The terminal may receive the plurality of beams at the previous time and the plurality of beams at the current time from the first base station. The terminal may determine that the plurality of beams at the previous time and the plurality of beams at the current time have the same associated ID. The terminal may perform training of the AI/ML model using the plurality of beams at the previous time, which may degrade the inference performance of the AI/ML model.

Accordingly, the first base station may configure time stamp information for a time at which the associated ID is configured, together with the associated ID. The time stamp information may be configured using a predetermined number of bits, for example, 32 bits or 64 bits. The time stamp information may be configured in seconds or minutes from a specific time.

The terminal may receive a signal or channel through the plurality of beams at the current time from the first base station and may identify the associated ID and the time stamp information for the received plurality of beams. The terminal may identify that the associated ID of the plurality of beams at the current time is the same as the associated ID of the plurality of beams received at the previous time. The terminal may identify the time stamp information of the plurality of beams at the current time and, if the identified time stamp information is more recent, may determine that the associated ID of the plurality of beams at the current time is a new associated ID. Therefore, the terminal may discard the plurality of beams received at the previous time or may not use them for training of the AI/ML model.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a base station, comprising:
configuring a first resource set and a second resource set for training and inference operations of an artificial intelligence/machine learning (AI/ML) model;
determining whether the first resource set and the second resource set are identical and configuring an associated identifier (ID) for each of the first resource set and the second resource set; and
transmitting a signal to a terminal based on at least one of a plurality of beams corresponding to the associated ID of the first resource set or a plurality of beams corresponding to the associated ID of the second resource set.

2. The method according to claim 1, wherein each of the first resource set and the second resource set includes Set A and Set B, and the configuring of the first resource set and the second resource set comprises: configuring at least one of the Set A and the Set B in one resource configuration information element (IE) among a plurality of IEs according to a channel state information (CSI) framework.

3. The method according to claim 2, wherein each of the first resource set and the second resource set further includes Set C, and the configuring of the first resource set and the second resource set further comprises: configuring the Set C by selecting one or more resource set IEs from among a plurality of resource set IEs of a new IE.

4. The method according to claim 1, wherein the configuring of the associated ID comprises:
determining whether a plurality of beams of the first resource set and a plurality of beams of the second resource set are identical;
based on a determination that the plurality of beams of the first resource set are identical to the plurality of beams of the second resource set, configuring an identical associated ID to each of the first resource set and the second resource set; and
based on a determination that the plurality of beams of the first resource set are not identical to the plurality of beams of the second resource set, configuring different associated IDs to the first resource set and the second resource set.

5. The method according to claim 4, wherein the determining of whether the plurality of beams of the first resource set and the plurality of beams of the second resource set are identical comprises: determining whether at least one of beam direction, beam order, beam transmission configuration indicator (TCI) state ID, or beam CSI reference signal resource indicator (CRI) value is identical between the plurality of beams of the first resource set and the plurality of beams of the second resource set.

6. The method according to claim 1, wherein the configuring of the associated ID comprises:
determining whether the second resource set is a subset of the first resource set; and
based on a determination that the second resource set is a subset of the first resource set, configuring a subset ID together with the associated ID.

7. The method according to claim 1, wherein the configuring of the associated ID comprises: configuring time stamp information for a time of configuring the associated ID for each of the first resource set and the second resource set.

8. The method according to claim 1, wherein the configuring of the associated ID comprises:
configuring a cell-specific associated ID in a portion of an entire bit region for the associated ID; and
configuring a vendor-specific associated ID in a remaining portion of the entire bit region for the associated ID.

9. A base station comprising at least one processor, wherein the at least one processor causes the base station to perform:
configuring a first resource set and a second resource set for training and inference operations of an artificial intelligence/machine learning (AI/ML) model;
determining whether the first resource set and the second resource set are identical and configuring an associated identifier (ID) for each of the first resource set and the second resource set; and
transmitting a signal to a terminal based on at least one of a plurality of beams corresponding to the associated ID of the first resource set or a plurality of beams corresponding to the associated ID of the second resource set.

10. The base station according to claim 9, wherein each of the first resource set and the second resource set includes Set A and Set B, and in the configuring of the first resource set and the second resource set, the at least one processor further causes the base station to perform: configuring at least one of the Set A and the Set B in one resource configuration information element (IE) among a plurality of IEs according to a channel state information (CSI) framework.

11. The base station according to claim 10, wherein each of the first resource set and the second resource set further includes Set C, and in the configuring of the first resource set and the second resource set, the at least one processor further causes the base station to perform: configuring the Set C by selecting one or more resource set IEs from among a plurality of resource set IEs of a new IE.

12. The base station according to claim 9, wherein in the configuring of the associated ID, the at least one processor further causes the base station to perform:
determining whether a plurality of beams of the first resource set and a plurality of beams of the second resource set are identical;
based on a determination that the plurality of beams of the first resource set are identical to the plurality of beams of the second resource set, configuring an identical associated ID to each of the first resource set and the second resource set; and
based on a determination that the plurality of beams of the first resource set are not identical to the plurality of beams of the second resource set, configuring different associated IDs to the first resource set and the second resource set.

13. The base station according to claim 12, wherein in the determining of whether the plurality of beams of the first resource set and the plurality of beams of the second resource set are identical, the at least one processor further causes the base station to perform: determining whether at least one of beam direction, beam order, beam transmission configuration indicator (TCI) state ID, or beam CSI reference signal resource indicator (CRI) value is identical between the plurality of beams of the first resource set and the plurality of beams of the second resource set.

14. The base station according to claim 9, wherein in the configuring of the associated ID, the at least one processor further causes the base station to perform:
determining whether the second resource set is a subset of the first resource set; and
based on a determination that the second resource set is a subset of the first resource set, configuring a subset ID together with the associated ID.

15. The base station according to claim 9, wherein in the configuring of the associated ID, the at least one processor further causes the base station to perform: configuring time stamp information for a time of configuring the associated ID for each of the first resource set and the second resource set.

16. The base station according to claim 9, wherein in the configuring of the associated ID, the at least one processor further causes the base station to perform:
configuring a cell-specific associated ID in a portion of an entire bit region for the associated ID; and
configuring a vendor-specific associated ID in a remaining portion of the entire bit region for the associated ID.

17. A method of a terminal, comprising:
receiving, from a base station, a signal based on a plurality of beams for a first resource set at a first time;
performing a training operation of an artificial intelligence/machine learning (AI/ML) model using the plurality of beams of the first resource set;
receiving, from the base station, a signal based on a plurality of beams for a second resource set at a second time;
determining whether an associated ID of the first resource set is identical to an associated ID of the second resource set; and
based on a determination that the associated ID of the first resource set is identical to the associated ID of the second resource set, performing an inference operation of the AI/ML model using the plurality of beams of the second resource set.

18. The method according to claim 17, wherein the performing of the inference operation comprises:
comparing first time stamp information at a time of configuring the associated ID for the first resource set with second time stamp information at a time of configuring the associated ID for the second resource set; and
based on the second time stamp information being more recent than the first time stamp information, discarding the plurality of beams of the first resource set.
